(19) United States
(12) Patent Application Publication
(10) Pub. No.: US 2016/0117708 A1
(43) Pub. Date: Apr. 28, 2016

(54) METHODS AND SYSTEMS FOR REFERRING AND TRACKING MEDIA

(71) Applicant: Peter Murphy, Longwood, FL (US)

(72) Inventor: Peter Murphy, Longwood, FL (US)

(21) Appl. No.: 14/525,613

(22) Filed: Oct. 28, 2014

(51) Int. Cl. G06Q 30/02; H04L 29/06

(52) U.S. Cl. CPC G06Q 30/0214; H04L 65/607

(57) ABSTRACT

A system and computer implemented method is provided for referring and tracking content. The system and method include functionality for allowing a primary user to upload content, storing the content on a site owner database, generating unique links to the content for each primary user designated client, determining when the client has played the received content beyond a predetermined threshold, and soliciting the client to become a referring client upon the determination. The system and method also include functionality for allowing the referring client to receive a reward from the primary user when the referring client refers the content to others who also view the content beyond the predetermined threshold.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to the distribution and tracking of media content, and more particularly to a tool which can allow users to refer media to others, and be rewarded when the referred media has been successfully played.

BACKGROUND

The statements in this section merely provide background information related to the present disclosure and may not constitute prior art.

There are many known devices and systems for creating, uploading and playing media such as videos, pictures audio files and the like. As the amount of media continues to increase, so too does the difficulty in locating particular media content that might be of interest. In this regard, each and every day authors create and deposit hundreds of thousands of media files online for viewing on websites such as social media and/or media content sites such as YouTube®, for example.

Although these sites work well to provide a location where users can search and view content there is very little assurance that the media will ever be played, as each uploaded media file must compete with hundreds of thousands of other files on the site. As such, the best way to ensure that a media file gets played is to have someone recommend it; the best way to get someone to recommend something is to provide an incentive for them to do so.

Accordingly, there is a need for a media referral and tracking tool which can incentivize users for recommending media that is actually viewed by a recipient.

### SUMMARY OF THE INVENTION

Systems and methods for providing a media referral and tracking tool can include multiple platforms and user interfaces that are connected to a site owner system over a network. The system can function to allow a primary user to upload content which can be stored by the site owner. Links to the content can be generated by the site owner, and can be sent to clients of the primary user. Each of these links can include a unique identifier specific to that client.

The system can also include functionality for determining when the client has played the received content beyond a predetermined threshold, and can solicit the client to become a referring client upon the determination. The system can also include functionality for allowing the referring client to receive a reward from the primary user when the referring client refers the content to others who also view the content beyond the predetermined threshold.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows an exemplary network environment according to some embodiments of the technology.

FIG. 2 shows an exemplary flow diagram illustrating a method for referring and tracking media, according to one embodiment.

FIG. 3 shows an exemplary user interface of the system of FIG. 1.

FIG. 4 shows another exemplary user interface of the system of FIG. 1.

FIG. 5 shows another exemplary user interface of the system of FIG. 1.

FIG. 6 shows another exemplary user interface of the system of FIG. 1.

FIG. 7 shows another exemplary user interface of the system of FIG. 1.

FIG. 8 shows another exemplary user interface of the system of FIG. 1.

FIG. 9 shows another exemplary user interface of the system of FIG. 1.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Identical reference numerals are used for like elements of the invention or elements of like function. For the sake of clarity, only those reference numerals are shown in the individual figures which are necessary for the description of the respective figure.

### Definitions

As described throughout this document, the terms “media” and “content” shall be used interchangeably to describe any form of digital content such as audio, video, and photo content that has been, or is capable of being converted into a digital media file such as: Windows Media Audio (WMA), Windows Media Video (WMV), MP3, JPEG, AVI, and/or executable files, for example, to be played on a processor enabled device.

The term “Primary user” and “user” can be used interchangeably to describe any person, group or legal entity who is utilizing the below described system and method to distribute content to others. In this regard, the primary user can include a content generator such as an artist or musician, for example, or an entity that wishes to distribute content generated by others.

The terms “client” and “contact” can be used interchangeably to describe any person who receives content from the content generator using below described system and method. In this regard, a client can include a person or entity that is known by the primary user, or is unknown by the primary user. Groups of clients can be uploaded into the site owner system in the form of text and/or email contact lists, for example.

The term “recipient” is used to describe any person who receives content from the contact via the below described system and method.

The terms “site owner,” “system management” and/or “system administrator” are used interchangeably, and can include an individual, group or legal entity that is overseeing, providing and/or performing various aspects of the below described system and method steps.

In one preferred embodiment, various aspects of the methods and systems for referring and tracking media can be performed on a website having the name SeedMedia.net. Of course, this is for illustrative purposes only, as the below described functionality can be performed in any number of different manners, and can utilize any number of different websites, website URL's and/or computer networks. Additionally, it is contemplated that some or all of the functionality described herein can also be performed simultaneously via different websites that are directed towards individual markets and/or geographic locales. Such functionality can be performed under the direct supervision of the original site owner, or via secondary site owners through a franchise, licensing or other type of arrangement.

Methods and systems for referring and tracking media can function to allow content generators to upload content to the site owner, and distribute the same to any number of different clients. Once a client reviews the content, the client can be provided with the opportunity to send the viewed content to others in exchange for a reward from the content generator. Once a predetermined number of recipients have viewed the content from a client, that client will receive the offered reward.

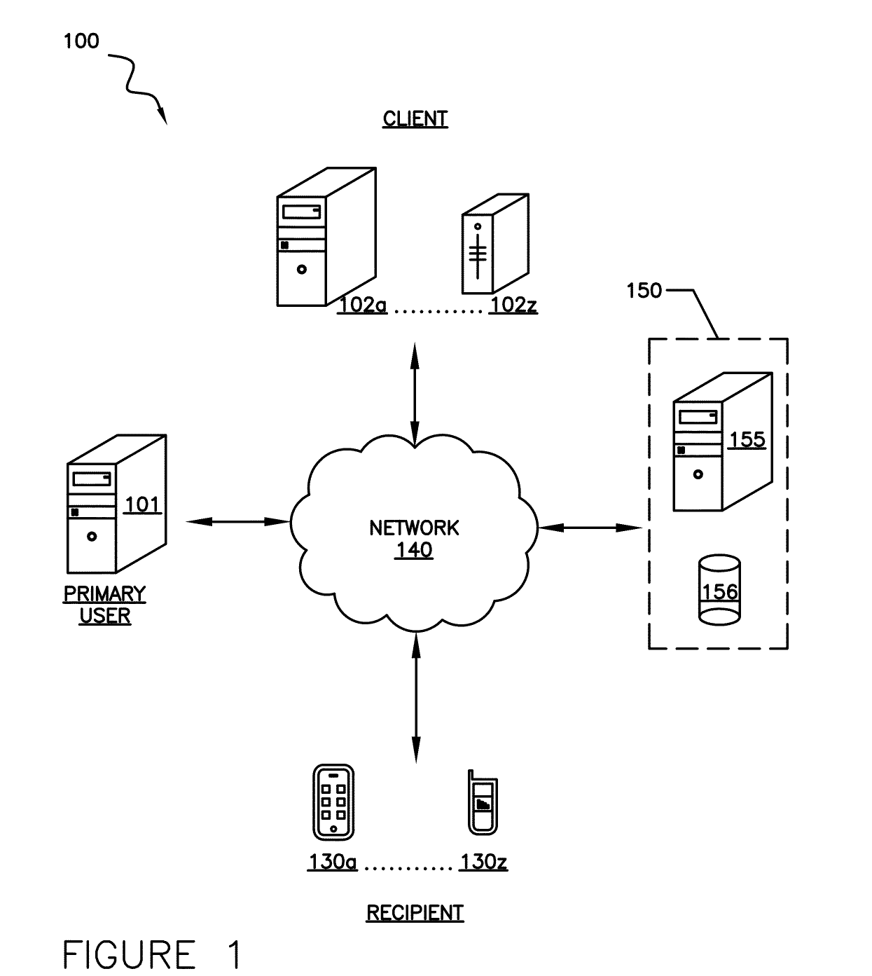

FIG. 1 is a schematic illustration of an exemplary system operating environment 100 for implementing a method for referring and tracking media. The system 100 can include, for example, at least one primary user interface device 101, one or more client interface devices 120a-120z, and one or more recipient interface devices 130a-130z that can be connected over a network 140 to a site owner server 150.

The site owner server 150, according to one embodiment, can include one or more individual computing devices 155 that can be connected to one or more databases 156 on which various portions of the method can be performed. The server 150 can function to provide a central hub for controlling the communication between the primary user interface 101, the client interface(s) 120 and the recipient interface(s) 130, through any number of different mediums such as the above noted website, for example. In this regard, one or more of the individual computing devices 155 can comprise a web server, an email server, an application database server and so forth, or the system can employ a single server device which functions to handle each of these processes.

In this regard, portions of the below described method can be implemented as a computer program product, i.e., a computer program tangibly embodied in a non-transient machine-readable storage device, for execution by, or to control the operation of, a data processing apparatus. The computer program can be written in any form of computer or programming language, including source code, compiled code, interpreted code, scripting code (e.g., JavaScript) and/or machine code, and the computer program can be deployed in any form, including as a stand-alone program or as a subroutine, element, or other unit suitable for use in a computing environment.

The database 156 can function to receive and store any form of information. In one embodiment, the database can function to receive and store media that is provided by the primary user. As described herein, the database 156 can include any type of computer-readable storage mediums, including all forms of volatile and non-volatile memory such as, for example, semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. In addition, the devices can be operatively coupled to a communications network, such as network 140, to receive instructions and/or data from the network and/or to transfer instructions and/or data to the network.

Each of the one or more interface devices 101, 120 and 130 can be any form of computing device such as a computer, tablet, smart phone or other such processor enabled device that can be operated by a human user. Moreover, each of the interface devices can also include one or more client applications, such as a web browser, for example, which can allow the device user to communicate with and view content from other devices over the network 140.

In various embodiments, the network 140 is a transmission medium that facilitates any form or medium or digital or analog communication (e.g., a communication network). Transmission mediums can include one or more packet-based networks and/or one or more circuit-based networks in any configuration. Packet-based networks can include, for example, the Internet, a carrier internet protocol (IP) network (e.g., local area network (LAN), and/or a wide area network (WAN). Circuit-based networks can include, for example, the public switched telephone network (PSTN), a wireless network (e.g., RAN, code-division multiple access (CDMA) network, time division multiple access (TDMA) network, global system for mobile communications (GSM) network), infrared transmissions, Blue Tooth or Personal Area Networks (PANs), Near Frequency Communication (NFC) network, and/or other circuit-based networks.

Information transfer over the network 140 can be performed by a communication module based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

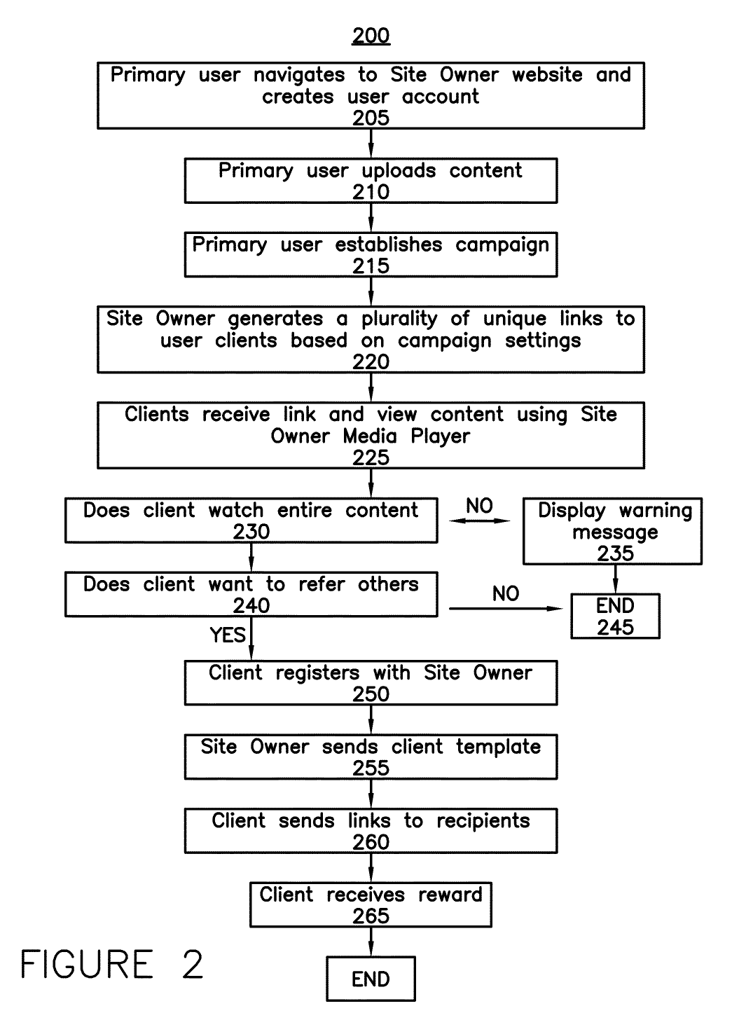

FIGS. 2-9 illustrate various methods and exemplary presentation screens for referring and tracking media. Although described below with regard to particular method steps, this is for illustrative purposes only, as the steps can be performed in any order, and can also include any number of different steps, in order to achieve the inventive concepts disclosed herein. Moreover, while the methods illustrated below can be implemented by (and in some cases, are described with respect to) the system 100 of FIG. 1, (or components thereof), these methods and/or method steps may also be implemented utilizing any suitable hardware implementation.

In operation, the site owner server can function to generate any number of presentation screens which can preferably be embodied in the form of a website and/or website pages that allow a primary user to upload and distribute content to others. Moreover, the system can further function to allow a primary user to offer rewards to clients who refer the content to others. Although not illustrated, the site owner server can establish any number of presentation screens in the form of website pages, for example, such as a landing page that can provide information about the method and services provided by the site owner, along with options for registering new users, and logging in existing users.

FIG. 2 is a flow chart illustrating an exemplary method for Referring and Tracking Media utilizing the system 100 described above. The method 200 can begin at step 205 in which a primary user establishes an account with the Site Owner. Although outside the scope of this document, it is to be understood that establishing an account can include, for example, providing information about the user, establishing payment preferences and establishing membership benefits such as a paid or unpaid plan, for example.

In either instance, once a primary user has established an account the method can proceed to step 210, wherein the primary user can upload one or more pieces of content which he or she wishes to share with others. As noted above, content can include any form of digital media such as audio files, video files, pictures, and executables, for example, that can be stored in the system database 156. At this time, and depending on the options selected by the primary user, the site owner can publish the uploaded content for immediate viewing on the site owner website via the below described SMPlayer.

Next, the method can proceed to step 215, wherein the site owner can present the primary user with options for establishing a campaign to distribute links for accessing the uploaded content. As described herein, user campaigns can function to allow each primary user to identify one or more clients, and to send each of the clients a unique and trackable link for playing the uploaded content on the SMPlayer. Moreover, once the client has played the link, he or she can be prompted with options for receiving a reward in exchange for sending the link to others.

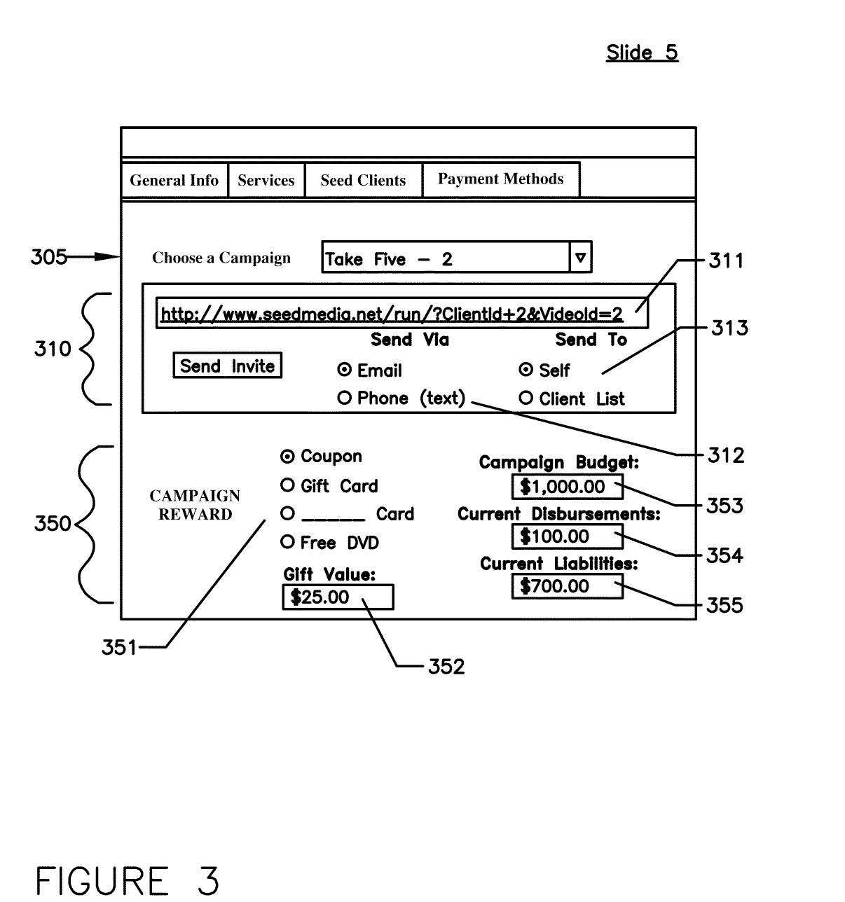

FIG. 3 illustrates an exemplary campaign settings presentation screen which can be generated by the site owner server and displayed to a primary user. As shown, the exemplary presentation screen can include the option to choose and/or select a campaign name 305, as well as detail options 310 which can include a designation of particular content 311, client delivery options 312 such as electronic mail, or by sending a text message to a client's smartphone, and to select which clients that will receive the generated content link(s) 313. Additionally, the presentation screen can include reward options 350 such as, for example, reward types 351 (e.g., coupons, gift cards, etc.,), individual reward type values 351, overall campaign budget 353, current disbursements 354 and/or current liabilities 355, for example.

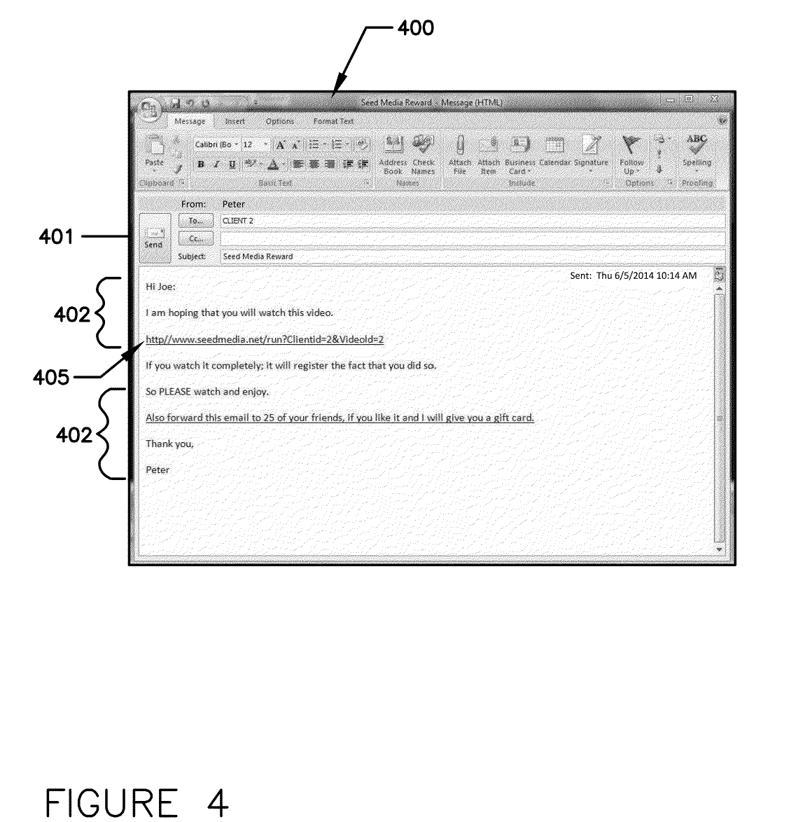

Once the primary user has established a campaign, the method can proceed to step 220, wherein the site owner can generate and send a unique link, such as a Uniform Resource Locator (URL), for example, to each client that was selected by the primary user when setting up the campaign. In this regard, each sent link can include an identifier that is unique to that particular client, such as the client id 405 shown below. In this regard, FIG. 4 illustrates an exemplary electronic message 400 which can be sent to a client 401 that was selected in the campaign settings. As shown, the message can include one or more standard or user customized messages 402, and a unique link 405 to view the uploaded content. In one embodiment, the system can automatically generate the message and distribute the same to each client, however other embodiments are contemplated wherein the primary user can manually send each message.

Next, the method can proceed to step 225, wherein the client activates the unique link, and is taken to the site owner website, or other such location, wherein the uploaded content can be viewed via the SMPlayer.

As described herein, the SMPlayer can include a downloadable media player or can reside on the site owner website, for example. The SMPlayer can include functionality for playing any number of different types of digital content such as video files, audio files, and executable files, such as games, for example. As the basic concepts and workings of media players are known in the art, they will not be repeated herein, however one suitable example of a media player includes the JW player that is commercially available by Longtail video.

In addition to playing the media files, the SMPlayer can also include functionality for recording the unique features of each unique link. For example, the SMPlayer can log the client id and/or the video campaign id that is included in the link. In another embodiment, the SMPlayer can also capture additional information such as device id of the user interface playing the content, and/or the date and time the media is satisfactorily played. This functionality can be added via an application programming interface (API) or can be included within the core programming of a standalone media player functioning as the SMPlayer. In either instance, once this information has been captured, the system can store the captured information in the system database, and a record of the same can be available to the primary user, in order to let them know the status of a campaign, and/or to let them know how many times a particular piece of content has been played.

Additionally, the SMPlayer can include functionality for determining if the content has been played beyond a predetermined threshold. This threshold can be established by the primary user when setting up each campaign, and can be anywhere from 1% of the total media file to 100% of the total media file, for example. In this regard, the method can proceed to step 230, wherein the SMPlayer can function to present one or more messages to the client who has accessed the link and is playing the content.

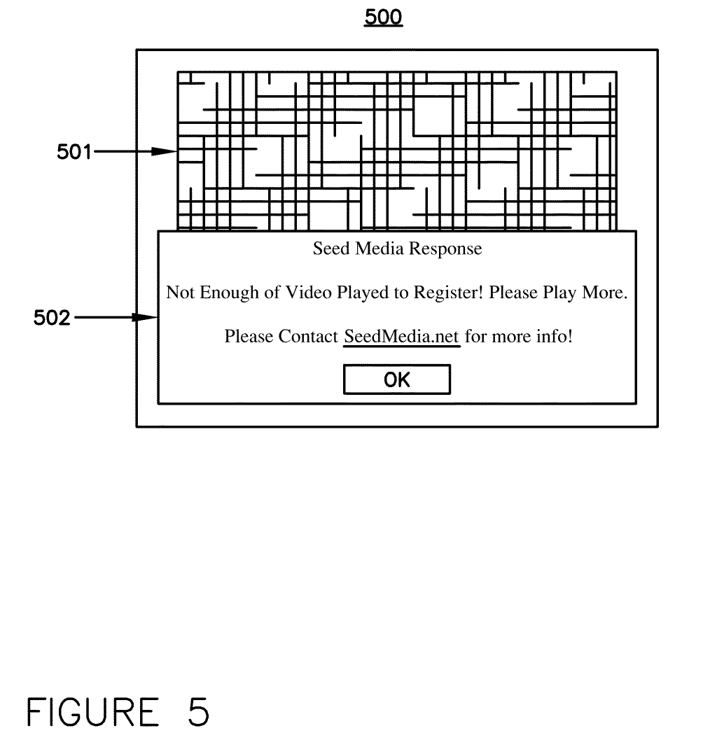

By way of example, FIG. 5 is an exemplary presentation screen illustrating the SMPlayer 500 playing content 501, which in this example is a video. As shown, if the client attempts to terminate the video before the predetermined threshold, the method can proceed to step 235, wherein the SMPlayer can display a warning message 502. As such, if the remaining portion of the video is not played, the client will not be eligible to register to receive a reward, and the method will terminate at step 245.

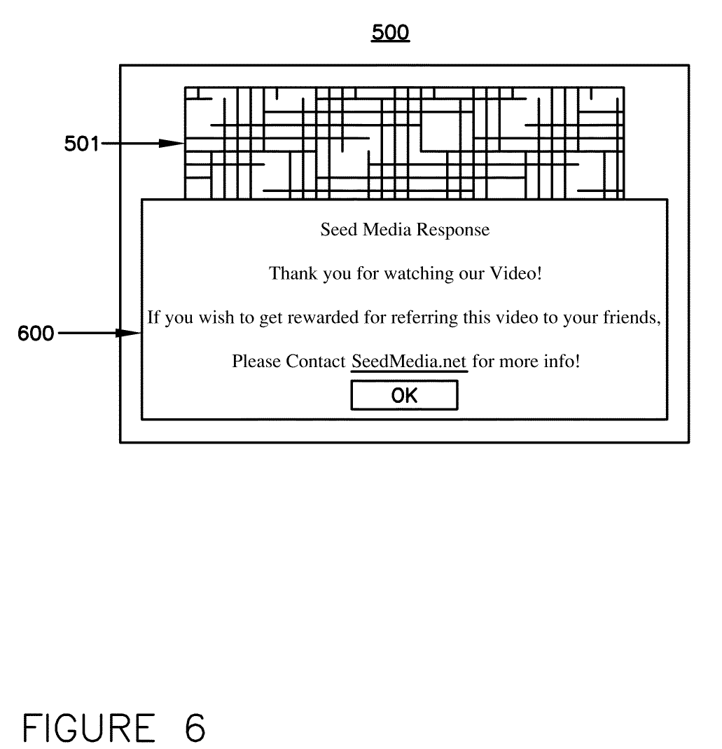

Conversely, FIG. 6 is an exemplary presentation screen illustrating the SMPlayer 500 playing content 501. In this example, SMPlayer has played the entire content, or enough to satisfy the predetermined threshold, and the method proceeds to step 240, wherein the client is provided with a client referral invitation 600. As shown, the invitation 600 can provide the client with an opportunity to refer the content 501 to others in exchange for a reward.

If the client does not wish to become a referring client, the method will proceed to step 245 and the SMPlayer will terminate. Alternatively, if the client does want to refer the content to others in exchange for a reward, the method can proceed to step 250, wherein the client can register with the system.

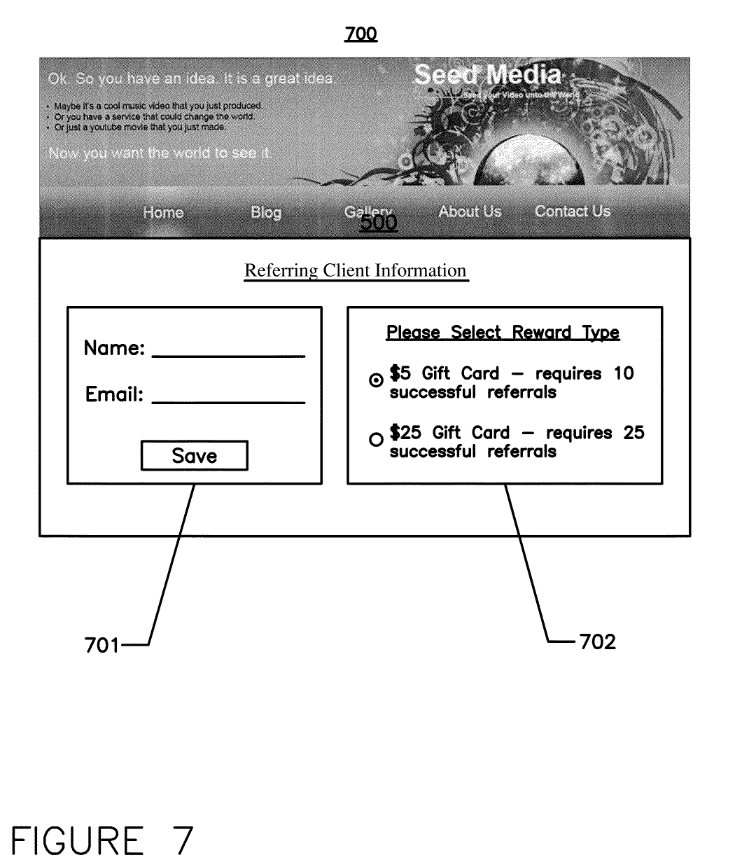

FIG. 7 illustrates an exemplary presentation screen 700 which can be generated by the site owner server and displayed to the referring client. As shown, the exemplary presentation screen can include options for receiving pertinent client information 701, such as contact information, mailing address, complete name and the like. Additionally, the screen can also include options for allowing the client to select the type and/or amount of the reward they wish to receive 702.

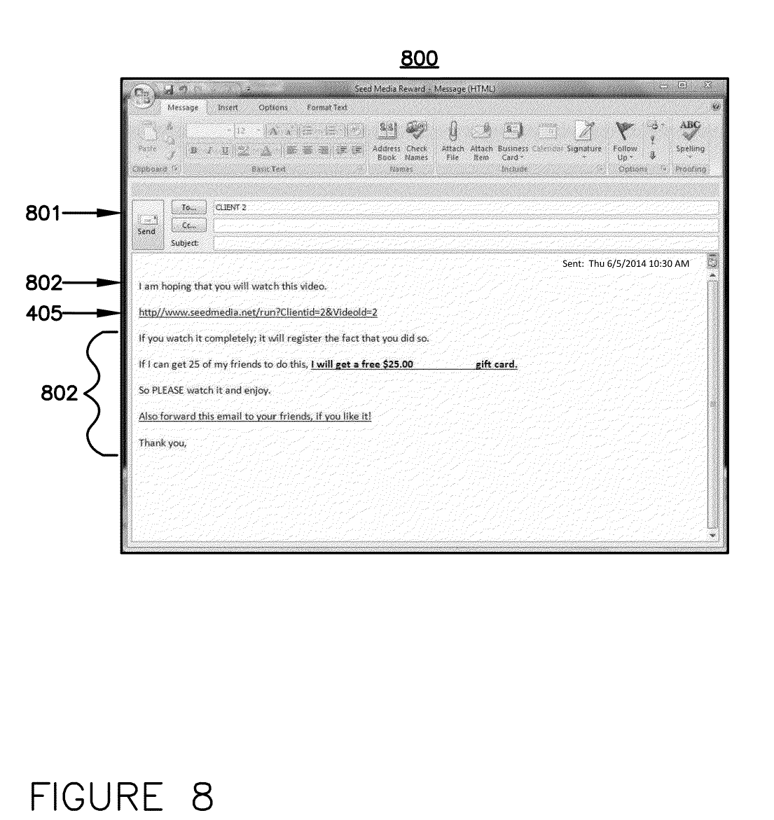

Once the client has successfully registered, the method can proceed to step 255, wherein the site owner system can generate and send the referring client a template which can be forwarded to others. In this regard, FIG. 8 illustrates an exemplary electronic message 800 which can be sent to the referring client 801. As shown, the message can include one or more standard or customized messages 802, and the client's unique link 405 to view the uploaded content.

At this time, the method can proceed to step 260, wherein the referring client can send the unique link to any number of recipients, who can view the content using the SMPlayer, as described above. In this regard, each time a new recipient plays the content, the SMPlayer can capture the recipients unique device id, (in order to ensure the same recipient does not get credit for playing the content multiple times), and can log the client id and/or the media campaign id that is included in the clients unique link. As such, only those plays that satisfy the predetermined threshold will count as a successful referral by the client, and once satisfied, this information can be stored in the system database, and a record of the same can be available to the primary user, in order to let them know the status of a campaign.

As such, when the client has performed the required number of successful referrals, the method can proceed to step 265, wherein the client can be notified that they have achieved the reward.

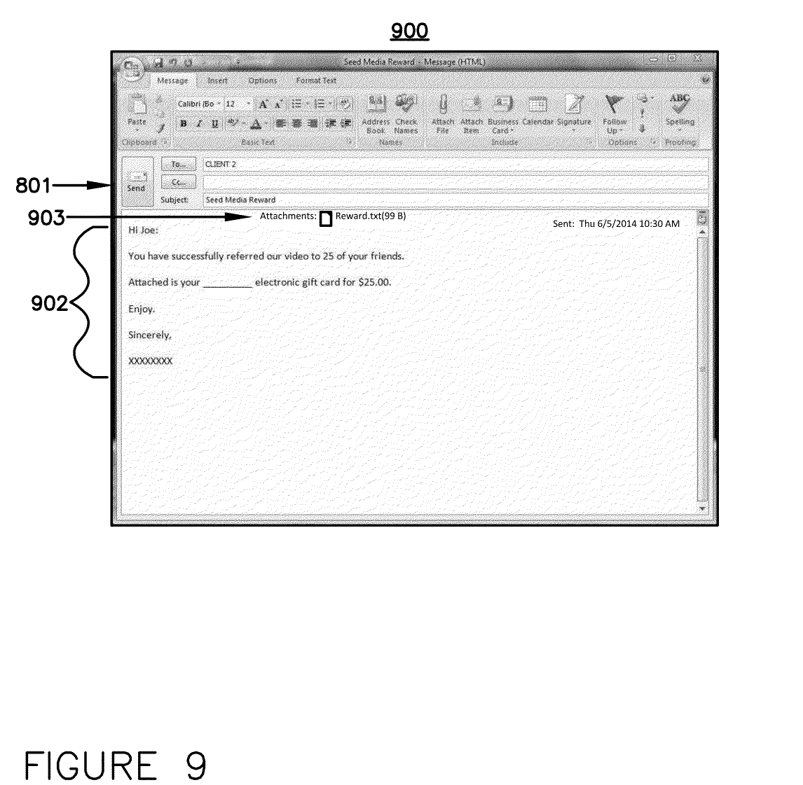

In one embodiment, the system can include functionality for submitting an electronic message to the client. In this regard, FIG. 9 illustrates an exemplary electronic message 900 which can be sent to the referring client 801. As shown, the message can include one or more standard or customized messages 902 alerting the client they have successfully referred the content. Moreover, in some embodiments, the message can further include an attachment or electronic link 903 containing the earned reward.

Although not illustrated, the method can also include options for automatically controlling and/or limiting the number of clients who are able to successfully register as referring clients based on the budget settings of the campaign.

Accordingly, the above described system and method steps provide a novel means for allowing a primary user to incentivize clients who recommend content that is actually viewed by a recipient.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for referring and tracking media, the method comprising:
establishing communication between a primary user interface device and a site owner system;
uploading, via the primary user interface device, one or more media files to the site owner system;
storing, via a system database, each of the one or more media files;
receiving, via the primary user interface, instructions for generating a campaign, said instructions including an identification of one of the media files, an identification of one or more clients, and reward information;
generating, via the site owner system, a unique link to the identified one media file, said link including a client id that is unique for each of the identified one or more clients;
sending, via the site owner system, the generated unique links to each of the selected clients;
determining, via the site owner system, that a client has activated a received unique link;
providing, via the site owner system, a SMPlayer device for playing the media files activated by the client; and
playing, via the SMPlayer, the media file identified in the client activated link.

2. The method of claim 1, further comprising:
determining that the identified media file has been played beyond a predetermined threshold;
generating a referring client registration screen, said screen including the reward information;
registering the client as a referring client;
generating and sending a referring client template to the referring client, said template including the clients unique link to the identified media file;
determining, via the site owner system, that a third person has activated the clients unique link to the identified media file;
playing, via the SMPlayer, the media file identified in the client activated link;
determining that the identified media file has been played beyond a predetermined threshold by the third person;
updating the referring clients registration for each determination that the identified media file has been played beyond a predetermined threshold; and
providing a reward identified in the reward information to the referring client.

3. The method of claim 1, further comprising:
determining that the identified media file has not been played beyond a predetermined threshold; and
generating a warning message to the client.

4. The method of claim 1, wherein said SMPlayer includes a digital media player that is configured to play the uploaded media file identified in the client activated link, and further comprising:
retrieving at least one of a unique device id, a referring clients account id, a date and time the media has been played beyond the predetermined threshold, and a media campaign id.

5. The method of claim 1, wherein said predetermined threshold is established by the primary user and is included in the instructions for generating the campaign.

6. The method of claim 5, wherein said predetermined threshold includes a range of between 1 percent of an entire length of the media file and 100 percent of an entire length of the media file.

7. A system referring and tracking media, said system comprising:
a site owner server device that functions to communicate with one or more primary user interface devices, and one or more client interface devices, said site owner device including functionality for:
receiving and storing one or more media files from the primary user interface device;
receiving, instructions for generating a campaign from the primary user interface device, said instructions including an identification of one of the media files, an identification of one or more clients, and reward information;
generating, a unique link to the identified one media file, said link including a client id that is unique for each of the identified one or more clients;
sending the generated unique links to each of the selected clients;
determining that a client has activated a received unique link;
providing, a SMPlayer device for playing the media files activated by the client; and
playing, the media file identified in the client activated link.

8. The computer program product of claim 7, wherein said SMPlayer comprises:
a digital media player that is configured to play the uploaded media file identified in the unique link, and to collect at least one of a unique device id, a referring clients account id, a date and time the media has been played beyond the predetermined threshold, and a media campaign id.

9. A computer program product, tangibly embodied in a non-transitory computer readable medium, for referring and tracking media, the computer program product including instructions being operable to cause a data processing apparatus to:
establishing communication with a primary user interface device;
receive and store one or more media files from the primary user interface device;
receiving, instructions for generating a campaign from the primary user interface device, said instructions including an identification of one of the media files, an identification of one or more clients, and reward information;
generating, a unique link to the identified one media file, said link including a client id that is unique for each of the identified one or more clients;
sending the generated unique links to each of the selected clients;
determining that a client has activated a received unique link;
providing, a SMPlayer device for playing the media files activated by the client; and
playing, the media file identified in the client activated link.

10. The computer program product of claim 9, further comprising:
determining that the identified media file has been played beyond a predetermined threshold;
generating a referring client registration screen, said screen including the reward information;
registering the client as a referring client;
generating and sending a referring client template to the referring client, said template including the clients unique link to the identified media file;
determining, that a third person has activated the clients unique link to the identified media file;
playing, the media file identified in the client activated link via the SMPlayer;
determining that the identified media file has been played beyond a predetermined threshold by the third person;
updating the referring clients registration for each determination that the identified media file has been played beyond a predetermined threshold; and
providing a reward identified in the reward information to the referring client.

11. The computer program product of claim 9, further comprising:
determining that the identified media file has not been played beyond a predetermined threshold; and
generating a warning message to the client.

12. The computer program product of claim 9, wherein said SMPlayer includes a digital media player that is configured to play the uploaded media file identified in the client activated link, and further comprising:
retrieving at least one of a unique device id, a referring clients account id, a date and time the media has been played beyond the predetermined threshold, and a media campaign id.

13. The computer program product of claim 9, wherein said predetermined threshold is established by the primary user and is included in the instructions for generating the campaign.

14. The computer program product of claim 13, wherein said predetermined threshold includes a range of between 1 percent of an entire length of the media file and 100 percent of an entire length of the media file.
